(19) United States
(12) Patent Application Publication
(10) Pub. No.: US 2025/0391130 A1
(43) Pub. Date: Dec. 25, 2025

(54) REMOTE OPERATION OF FACILITIES USING EXTENDED REALITY DEVICES

(71) Applicant: Schlumberger Technology Corporation, Sugar Land, TX (US)

(72) Inventors: Nasser Ghorbani, Houston, TX (US); Rajat Lokesh, Menlo Park, CA (US); Vineet Kamboj, Menlo Park, CA (US)

(21) Appl. No.: 19/243,365

(22) Filed: Jun. 19, 2025

Related U.S. Application Data
(60) Provisional application No. 63/661,788, filed on Jun. 19, 2024.

(51) Int. Cl. G06T 19/00; G06V 20/20; G06V 20/40; G06V 20/52; H04N 7/18

(52) U.S. Cl. CPC G06T 19/006; G06V 20/20; G06V 20/40; G06V 20/52; H04N 7/183

(57) ABSTRACT

The present disclosure relates to systems and methods for remote operations of a facility using an extended reality device. The systems and methods receive a video feed of the facility and present on a display of the extended reality device the video feed. The systems and methods provide real-time data visualization of the facility using the extended reality device. The systems and methods cause an action to be performed at the facility in response to the video feed.

### CROSS REFERENCE TO RELATED APPLICATION(S)

This application claims priority to and benefit of U.S. Provisional Patent Application No. 63/661,788 filed on Jun. 19, 2024, which is incorporated by reference herein in its entirety.

### BACKGROUND

Extended Reality (XR) is a collective term encompassing augmented reality (AR), virtual reality (VR), and mixed reality (MR). XR represents a wide spectrum of immersive technologies that blend the physical and digital worlds. XR allows users to engage with digital content in a life-like manner, creating environments where virtual and real elements coexist and interact in real-time. XR technology has applications across various sectors, including entertainment, education, healthcare, and industry, offering enhanced experiences and interactive opportunities. As XR continues to evolve, it is expected to transform how we work, learn, and connect with each other.

### BRIEF SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Some implementations relate to a method. The method includes receiving, from a camera at a facility, a video feed of the facility. The method includes presenting, on a display of an extended reality (XR) device, the video feed. The method includes causing an action to be performed at the facility in response to the video feed.

Some implementations relate to a device. The device includes a memory to store data and instructions; and a processor operable to communicate with the memory, wherein the processor is operable to: receive, from a camera at a facility, a video feed of the facility; present, on a display of an extended reality (XR) device, the video feed; and cause an action to be performed at the facility in response to the video feed.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for monitoring facilities using extended reality devices in accordance with implementations of the present disclosure.

FIG. 2 illustrates an example of a virtual reality view of a facility presented on an extended reality device in accordance with implementations of the present disclosure.

FIG. 3 illustrates an example of an augmented reality view of an item in a facility presented on an extended reality device in accordance with implementations of the present disclosure.

FIG. 4 illustrates an example method for monitoring facilities using extended reality devices in accordance with implementations of the present disclosure.

FIG. 5 illustrates components that may be included within a computer system.

### DETAILED DESCRIPTION

This disclosure generally relates to Extended Reality (XR). XR is a collective term encompassing augmented reality (AR), virtual reality (VR), and mixed reality (MR). AR adds digital elements over real-world views with limited interaction. VR is a simulated experience that provides a user an immersive feel of a virtual world usually via a headset device and headphones. MR combines AR and VR elements so that digital objects can interact with the real world. XR represents a wide spectrum of immersive technologies that blend the physical and digital worlds. XR allows users to engage with digital content in a life-like manner, creating environments where virtual and real elements coexist and interact in real-time.

Oil and gas production facilities are complex environments that include a wide range of sophisticated equipment and process. Oil and gas facilities include separators, compressors, valves, pipes, heat exchanges, vessels, pumps, storage tanks, and various control systems. The equipment used in oil and gas facilities if often large, intricate, and located in remote or hazardous areas, making the maintenance, monitoring and operation challenging. Moreover, the harsh environmental conditions, such as extreme temperatures, high pressures, and corrosive substance require regular inspection and maintenance to ensure safe and efficient operation. The complexity of these facilities and the critical nature of their equipment highlight the need for advanced technologies and strategies to optimize production, minimize downtime, and ensure the safety of personnel and the environment.

The present disclosure provides systems and methods for remote operations of facilities using XR devices. In some implementations, the facilities are oil and gas facilities. The present disclosure includes a number of practical applications that provide benefits and/or solve problems associated with remote operations of facilities using XR devices. Examples of these applications and benefits are discussed in further detail below.

The systems and methods provide a new experience in the oil and gas industry which enable users to access the vast majority of information much faster and easier and providing an ability to remotely have a full control of the facility without sitting behind a desk or requiring several monitors. The systems and methods offer unique benefits for remote operation and monitoring of oil and gas production facilities that go beyond traditional screens. The systems and methods provide an immersive, hands-free experience that enhances spatial awareness, enables real-time data visualization, and improves remote collaboration.

By overlaying digital information onto the real-world view, the systems and methods reduce cognitive load, improve situational awareness, and enable faster skill acquisition. Additionally, the systems and methods help reduce errors, improve quality, and provide workers with instant access to critical information in context. These AR-specific advantages, combined with the general benefits of remote monitoring and operation, optimize the performance, safety, and efficiency of oil and gas production facilities.

The systems and methods of the present disclosure enable users (e.g., operators of facilities) to monitor and manage various aspects of the facilities using XR devices. In some implementations, the users are remote from the facilities and the XR devices are capable of remote monitoring and remote operations. For example, the users are remote operators of oil and gas facilities. In some implementations, the users are onsite at the facilities and use the XR devices to monitor and manage various aspects of the facilities. The XR devices are capable of monitoring, operation, and providing real-time support. Examples of XR devices include APPLE VISION PRO by APPLE and META QUEST 3 by META. In some implementations, the methods and systems use brain computer interfaces (BCIs) devices to remotely manage a facility.

In some implementations, the XR devices receive video feeds from the facility directly in the XR devices. In some implementations, the video feeds are provided by one or more cameras at the facility. One example camera is a camera that provides a 360 degree view. For example, a robot or drone has a camera that provides a 360 degree view from a point of view of the robot or drone of the facility. In some implementations, the video feeds are presented in AR. In some implementations, the video feeds are presented in VR. In some implementations, the video feeds are presented in MR. In some implementations, a 3D map of a facility is provided to the XR devices. For example, a 3D overview map of the facility is presented on the XR devices. In some implementations, the XR devices receive data generated by the one or more cameras or other sensors in the facility. Examples of the data generated by the cameras include Lidar, infrared, and sensor readings. Being able to see an overview of the facility that shows a location and status of different entities (e.g., robots, personnel, and machinery) using the XR devices allows the users to see and react to various events and/or alerts in the facility. In some implementations, the XR devices allow the users to take direct control of drones, robots, and/or machinery and operate the drones, robots, and/or machinery while having an immersive 360 degree view from the cameras shown in the XR device.

The systems and methods provide an immersive experience by overlaying digital information onto the user's real-world view, creating a more intuitive and engaging interaction with the environment and equipment. In some implementations, the systems and methods virtually overlay equipment components during maintenance and inspection, overlaying the digital twin in real-time on the physical asset as request for performance comparison with running what-if scenarios, and more. For example, the systems and methods identify machinery in the facility and present an overlay of inspection and/or maintenance instructions on top of the machinery in the XR device.

One example use of the systems and methods include a computing device at a facility performing inspections of machinery at the facility. One example of the computing device is a robot. Another example of the computing device is a drone. Another example of the computing device is tablet. Another example of the computing device is an XR device. The computing device detects a leak in a machinery and provides a video of the leaking machinery to an XR device of a user. The user views the video using the XR device and takes control of the computing device to fix the leak using the live video feed from the robot at the facility.

Another example use of the systems and methods include a computing device identifies a piece of equipment that is malfunctioning at the facility. One example of the computing device is a drone. Another example of the computing device is a robot. Another example of the computing device is an XR device. Another example of the computing device is a portable device. The computing device sends a video of the equipment to an XR device of a user. The user of the XR device identifies the problem and sends a detailed set of instructions to a technician located at the facility for fixing the equipment. The detailed set of instructions are presented using augmented reality on an XR device at the facility used by the technician. The detailed instructions are presented next an image of the equipment so that the technician can view the steps while fixing the equipment.

One technical advantage of the systems and methods of the present disclosure is enabling remote operations and monitoring of oil and gas production facilities. Another technical advantage of the systems and methods of the present disclosure is enabling users to remotely have full control of a facility without sitting behind a desk or requiring several monitors. AR devices allow users (e.g., engineers) to access information and interact with systems hands-free, enabling the users to be more efficient and available.

Another technical advantage of the systems and methods of the present disclosure is providing an immersive, hands-free experience that enhances spatial awareness, enables real-time data visualization, and improves remote collaboration. By overlaying digital information onto the real-world view, this method reduces cognitive load, improves situational awareness, and enables faster skill acquisition. The AR provides an immersive experience by overlaying digital information onto the user's real-world view, creating a more intuitive and engaging interaction with the environment and equipment. AR technology also provides users with a better sense of spatial awareness, allowing the users to understand the layout and scale of a facility and equipment more effectively than traditional 2D screens.

Another technical advantage of the systems and methods of the present disclosure is providing access to information faster and easier. The systems and methods provide real-time data visualization to users. AR superimposes real-time data, such as sensor readings, directly onto the relevant equipment or components, providing users with instant access to critical information in context. The systems and methods provide improved situational awareness. AR can highlight potential hazards, display safety guidelines, and provide emergency procedures in the context of the user's environment, enhancing situational awareness and reducing the risk of accidents. The systems and methods provide enhanced remote collaboration. AR enables remote experts to share their view and provide guidance to on-site personnel as if they were physically present, using virtual annotations, 3D models, and real-time markups.

Another technical advantage of the systems and methods of the present disclosure is reducing cognitive load. By presenting information in a visually intuitive manner and minimizing the need to switch between multiple screens or systems, AR can reduce the cognitive load on users, improving focus and decision-making abilities.

Another technical advantage of the systems and methods of the present disclosure is helping to reduce errors, improving quality, and providing users with instant access to critical information in context. By providing users with step-by-step instructions, visual cues, and real-time feedback, AR can help reduce errors and improve the quality of maintenance, repair, and operation tasks. The systems and methods aid in faster skill acquisition. AR-based training allows workers to learn and practice tasks in a realistic, interactive environment, leading to faster skill acquisition and improved knowledge retention compared to traditional training methods. For example, if an operator or robot is onsite at a facility, the systems and methods allow a remote operator to use the XR devices to guide the operator onsite or the robot onsite.

The XR-specific advantages, combined with the general benefits of remote monitoring and operation, allows the systems and methods of the present disclosure to provide a powerful tool for optimizing the performance, safety, and efficiency of oil and gas production facilities. For example, the systems and methods allow users to use the XR devices to efficiently run oil and gas facilities remotely by enabling information to be visualized within a relevant context.

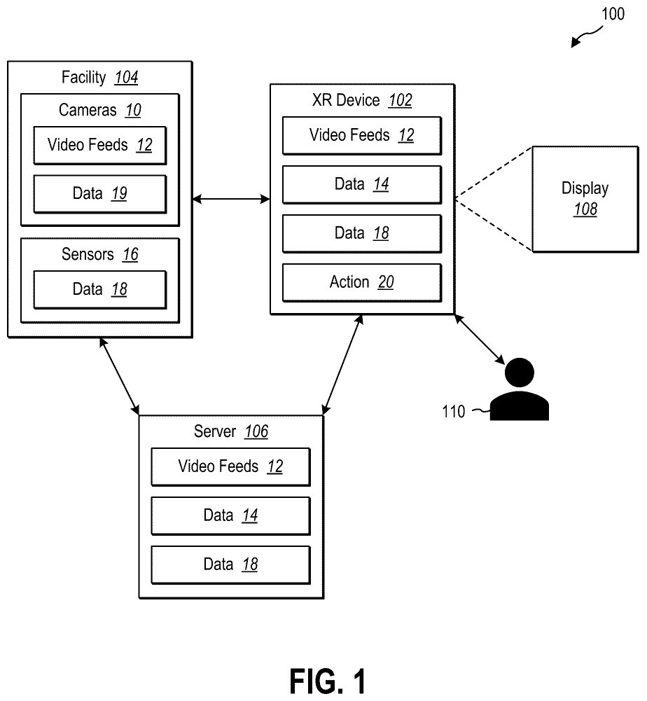

Referring now to FIG. 1, illustrated is an example environment 100 for operations of a facility 104 by a user 110 using an XR device 102. Examples of the XR device 102 include a headset worn by the user 110, glasses worn by the user 110, a mobile device such as a mobile telephone, a smartphone, a personal digital assistant (PDA), a tablet, a laptop, or any other portable device, and non-mobile devices such as a desktop computer. In some implementations, the environment 100 includes a plurality of XR devices 102 that are used by one or more users 110 to manage the facility 104. In some implementations, the environment 100 includes a plurality of facilities 104 that are managed by one or more users 110 using XR devices 102.

In some implementations, the facility 104 is in communication with the XR device 102 through a network. The network may include one or multiple networks and may use one or more communication platforms and/or technologies suitable for transmitting data. The network may refer to any data link that enables transport of electronic data between devices of the environment 100. The network may refer to a hardwired network, a wireless network, or a combination of a hardwired network and a wireless network. In one or more implementations, the network includes the internet. The network may be configured to facilitate communication between the various computing devices via well-site information transfer standard markup language (WITSML) or similar protocol, or any other protocol or form of communication.

In some implementations, the XR device 102 receives video feeds 12 from cameras 10 at the facility 104 and presents the video feeds 12 on a display 108 of the XR device 102. In some implementations, the cameras 10 are on different drones in the facility 104. In some implementations, the cameras 10 are on different robots in the facility 104. In some implementations, the cameras 10 provide a 360 degree view of the facility 104. The video feeds 12 provide the user 110 a live feed of what is occurring in the facility 104.

In some implementations, the XR device 102 receives data 14 obtained from the cameras 10 at the facility 104 and presents the data 14 on the display 108 of the XR device 102. Examples of the data 14 include lidar data obtained by the cameras 10, infrared data obtained by the cameras 10 and depth data obtained by the cameras 10.

In some implementations, the XR device 102 receives data 18 obtained from different sensors 16 in the facility and presents the data 14 on the display 108 of the XR device 102. For example, the sensors 16 are on different machinery in the facility 104. Another example includes the sensors 16 are on different robots in the facility. Another example includes the sensors 16 are on different drones in the facility. Another example includes the sensors 16 are thermal sensors.

In some implementations, the data 14 and/or the data 18 is presented in an overlay on the display over the cameras 10, machinery, equipment, robot, and/or drone that provided the data 14, 18. Overlaying the digital information onto the user's 110 real-world view (e.g., via the video feeds 12) of the facility 104 provides the user 110 an immersive experience. In some implementations, the data 14, 18 is asynchronous data. In some implementations, the data 14, 18 is synchronous data.

In some implementations, a server 106 is in communication with the facility 104 and the XR device 102 via the network. The server 106 may include one or more computing devices (e.g., including processing units, data storage, etc.) organized in an architecture with various network interfaces for connecting to and providing data management and distribution across one or more client systems. In some implementations, the server 106 receives the video feeds 12 and the data 14, 18 from the facility 104 and stores the video feeds 12 and the data 14, 18. In some implementations, the XR device 102 obtains the video feeds 12 and the data 14, 18 from the server 106.

In some implementations, a machine learning model is in communication with the XR device 102 and receives the video feeds 12 and the data 14, 18 as input. The machine learning model is trained to identify different items (e.g., machinery, cameras, drones, robots, and/or sensors) in the facility 104. In some implementations, the machine learning model processes the received data 14, 18 and generates a prediction of a status of the detected items. In some implementations, the machine learning model processes the received data 14, 18 and generates insights for the detected items.

In some implementations, the user 110 performs one or more actions 20 in response to receiving the video feeds 12 and/or the data 14, 18. In some implementations, the user 110 performs the action 20 in response to the insights provided by the machine learning model. In some implementations, the user 110 performs the action 20 in response to a status of the items (e.g., machinery, robots, drones, sensors, the cameras 10) in the facility 104 or a status (e.g., an unavailable status) of personnel in the facility 104. An example action 20 includes the user 110 using the XR device 102 to remotely take control of a drone in the facility 104. Another example action 20 includes the user 110 using the XR device 102 to remotely take control of a robot in the facility 104. Another example action 20 includes the user 110 using the XR device 102 to remotely take control of equipment in the facility 104. Another example action 20 includes the user 110 using the XR device 102 to provide instructions or guidance for maintenance and repair of equipment in the facility 104.

The environment 100 enables the user 110 to monitor and manage various aspects of the facilities using the XR device 102. The environment 100 provides the user 110 an immersive, hands-free experience that enhances spatial awareness and enables real-time data visualization of the facility 104.

In some implementations, one or more computing devices (e.g., servers and/or devices) are used to perform the processing of the environments 100. The one or more computing devices may include, but are not limited to, server devices, cloud virtual machines, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. Moreover, in some implementations, one or more subcomponent of the feature and functionalities discussed herein may be implemented are processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

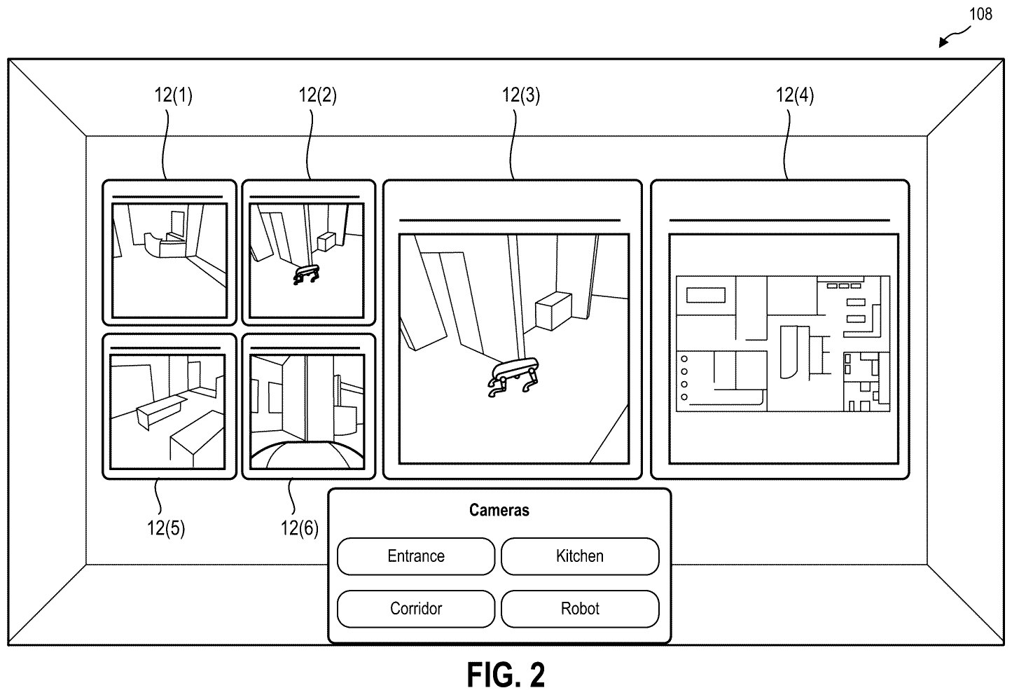

FIG. 2 illustrates an example of the XR device 102 (FIG. 1) providing a virtual reality view of the facility 104 (FIG. 1). For example, the virtual reality view of the facility 104 is presented on a display 108 of the XR device 102. The virtual reality view includes the video feeds 12(1), 12(2), 13(3), 12(4), 12(5), 12(6) from the cameras 10 (FIG. 1) at the facility 104. The user 110 (FIG. 1) can switch between the different camera views and see the different video feeds 12(1), 12(2), 13(3), 12(4), 12(5), 12(6) from the cameras 10. The virtual reality view provides the user 110 with an overview of the facility 104 where the user can view and/or monitor a location of different items in the facility 104 in real-time (e.g., robots, drones, equipment, or machinery) or where different personnel are located in the facility 104. In some implementations, the virtual reality view provides the user 110 a 360 degree view of the facility 104.

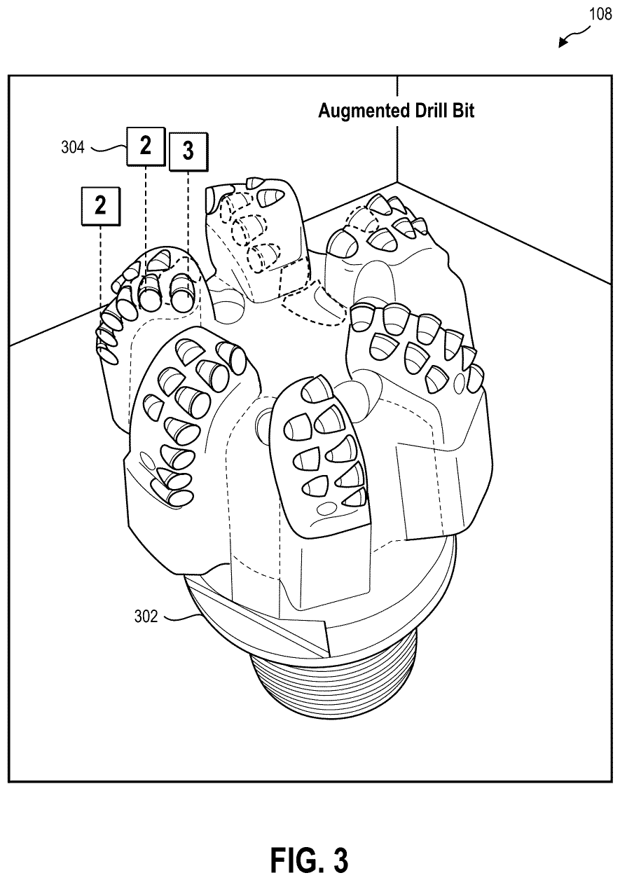

FIG. 3 illustrates an example of the XR device 102 (FIG. 1) providing augmented reality of an item 302 (e.g., a drill bit) located in a facility 104 (FIG. 1). For example, the augmented reality view of the item 302 is presented on a display 108 of the XR device 102. The augmented reality view overlays data 304 on the item 302. In some implementations, additional information is overlaid over the item 302. One example of the additional information is step by step instructions for repairing the item 302. One example use case includes the user 110 using the additional information overlaid on the drill bit using the augmented reality presented on the display 108 of the XR device 102 to perform a repair on the drill bit.

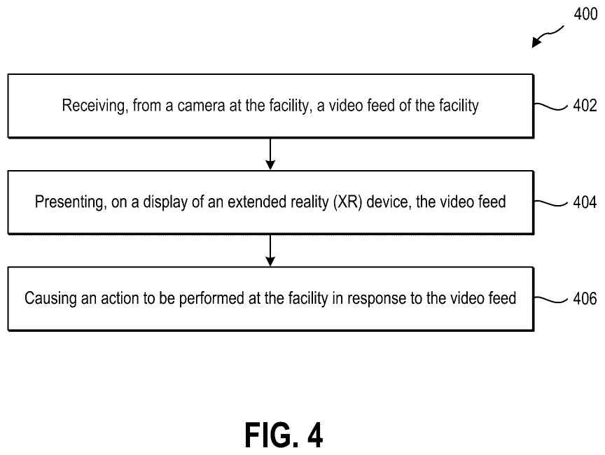

FIG. 4 illustrates an example method 400 for monitoring facilities using an XR device. The actions of the method 400 are discussed below in reference to FIGS. 1-3.

At 402, the method 400 includes receiving, from a camera at the facility, a video feed of the facility. The XR device 102 receives from a camera 10 at the facility 104 a video feed 12 of the facility 104. At 404, the method 400 includes presenting, on a display of an extended reality (XR) device, the video feed. The XR device 102 presents on a display 108 the video feed 12. At 406, the method 400 includes causing an action to be performed at the facility in response to the video feed. The XR device 102 causes an action 20 to be performed at the facility 104 in response to the video feed 12. The method 400 allows a user 110 to monitor the facility 104 using the XR device 102.

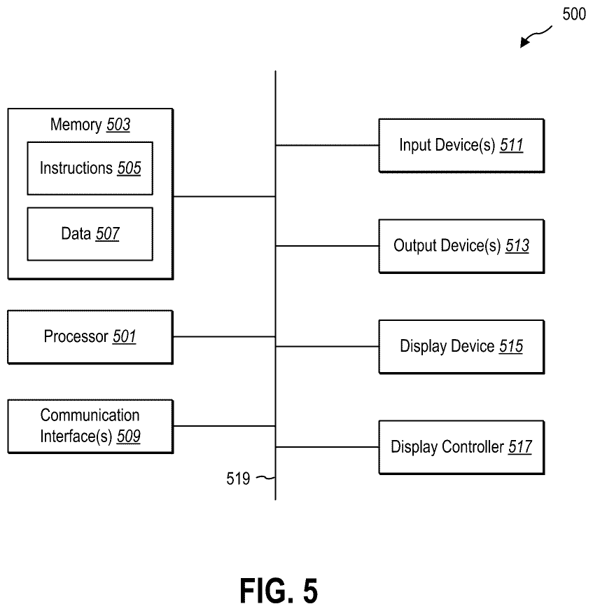

FIG. 5 illustrates components that may be included within a computer system 500. One or more computer systems 500 may be used to implement the various methods, devices, components, and/or systems described herein.

The computer system 500 includes a processor 501. The processor 501 may be a general-purpose single or multi-chip microprocessor (e.g., an Advanced RISC (Reduced Instruction Set Computer) Machine (ARM)), a special purpose microprocessor (e.g., a digital signal processor (DSP)), a graphics processing unit (GPU), a microcontroller, a programmable gate array, etc. The processor 501 may be referred to as a central processing unit (CPU). Although just a single processor 501 is shown in the computer system 500 of FIG. 5, in an alternative configuration, a combination of processors (e.g., an ARM and DSP) could be used.

The computer system 500 also includes memory 503 in electronic communication with the processor 501. The memory 503 may be any electronic component capable of storing electronic information. For example, the memory 503 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 505 and data 507 may be stored in the memory 503. The instructions 505 may be executable by the processor 501 to implement some or all of the functionality disclosed herein. Executing the instructions 505 may involve the use of the data 507 that is stored in the memory 503. Any of the various examples of modules and components described herein may be implemented, partially or wholly, as instructions 505 stored in memory 503 and executed by the processor 501. Any of the various examples of data described herein may be among the data 507 that is stored in memory 503 and used during execution of the instructions 505 by the processor 501.

A computer system 500 may also include one or more communication interfaces 509 for communicating with other electronic devices. The communication interface(s) 509 may be based on wired communication technology, wireless communication technology, or both. Some examples of communication interfaces 509 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 500 may also include one or more input devices 511 and one or more output devices 513. Some examples of input devices 511 include a keyboard, mouse, microphone, remote control device, button, joystick, trackball, touchpad, and lightpen. Some examples of output devices 513 include a speaker and a printer. One specific type of output device that is typically included in a computer system 500 is a display device 515. Display devices 515 used with embodiments disclosed herein may utilize any suitable image projection technology, such as liquid crystal display (LCD), light-emitting diode (LED), gas plasma, electroluminescence, or the like. A display controller 517 may also be provided, for converting data 507 stored in the memory 503 into text, graphics, and/or moving images (as appropriate) shown on the display device 515.

The various components of the computer system 500 may be coupled together by one or more buses, which may include a power bus, a control signal bus, a status signal bus, a data bus, etc. For the sake of clarity, the various buses are illustrated in FIG. 5 as a bus system 519.

In some implementations, the various components of the computer system 500 are implemented as one device. For example, the various components of the computer system 500 are implemented in a mobile phone or tablet. Another example includes the various components of the computer system 500 implemented in a personal computer. Another example includes the various components of the computer system 500 implemented in the cloud. Another example includes the various components of the computer system 500 implemented on an edge device.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model, a probabilistic graphical model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method comprising:
receiving, from a camera at a facility, a video feed of the facility;
presenting, on a display of an extended reality (XR) device, the video feed; and
causing an action to be performed at the facility in response to the video feed.

2. The method of claim 1, wherein the camera provides a three hundred and sixty degree view of the facility.

3. The method of claim 1, wherein the camera is on a robot at the facility.

4. The method of claim 1, wherein the camera is on a drone at the facility.

5. The method of claim 1, further comprising:
receiving, from a sensor at the facility, data; and
presenting, on the display of the XR device, the video feed with the data overlaying the video feed.

6. The method of claim 5, further comprising:
causing the action at the facility in response to the data.

7. The method of claim 5, wherein the sensor is on machinery or equipment at the facility.

8. The method of claim 5, wherein the sensor is on a robot at the facility.

9. The method of claim 5, wherein the sensor is on a drone at the facility.

10. The method of claim 1, wherein the action is performing a repair at the facility.

11. The method of claim 1, wherein the action is taking control of an item at the facility.

12. The method of claim 11, wherein the item is a robot, a drone, equipment, machinery, or the camera.

13. The method of claim 1, wherein the action is providing instructions for repairing an item at the facility.

14. The method of claim 13, wherein the instructions are presented on a display at a second XR device at the facility over the item.

15. The method of claim 1, further comprising:
receiving, from a sensor at the facility, data;
automatically identifying an item at the facility associated with the sensor; and
presenting, on the display of the XR device, the video feed with the data overlaying the item in the video feed.

16. The method of claim 1, wherein the XR device provides virtual reality of the facility.

17. The method of claim 1, wherein the XR device provides augmented reality of the facility.

18. The method of claim 1, wherein the XR device provides mixed reality of the facility.

19. The method of claim 1, further comprising:
presenting, on the display of an extended reality (XR) device, the video feed with a 3D map of the facility overlaying the video feed.

20. A device comprising:
a memory to store data and instructions; and
a processor operable to communicate with the memory, wherein the processor is operable to:
receive, from a camera at a facility, a video feed of the facility;
present, on a display of an extended reality (XR) device, the video feed; and
cause an action to be performed at the facility in response to the video feed.
